(19) United States
(12) Patent Application Publication
(10) Pub. No.: US 2020/0086212 A1
(43) Pub. Date: Mar. 19, 2020

(54) Easy-to-store Combined Wireless Gun-shaped Simulation Game Controller

(71) Applicant: Ka Yan WONG, Hong Kong (HK)

(72) Inventor: Ka Yan WONG, Hong Kong (HK)

(21) Appl. No.: 16/209,930

(22) Filed: Dec. 4, 2018

(30) Foreign Application Priority Data
Sep. 13, 2018 (CN) 201811070296.9

(51) Int. Cl. A63F 13/245; A63F 13/235; A63F 13/285; A63F 13/218; G06F 17/50

(52) U.S. Cl. CPC A63F 13/245; A63F 13/235; G06F 17/5009; A63F 13/218; A63F 13/285

(57) ABSTRACT

The invention relates to an easy-to-store combined wireless gun-shaped simulation game controller of the present invention which includes a gun-shaped body, a recoil simulation device, a barrel device, a reloading device, an aiming device and a controller. The gun-shaped body is provided with a bolt, a first distance sensor, a second distance sensor, a trigger and a rotary switch. The rotary switch includes a rotating wheel, a circular bracket, a marking recognition device and a position identifier. The recoil simulation device includes an electrical cylinder dispose in the buttstock, a support plate, a pair of guiding rods and a tension spring. The gun-shaped body is connected to the barrel device. The reloading device includes a pressure plate, a pressure sensor, a lithium battery and a second button. The easy-to-store combined wireless gun-shaped simulation game controller has a reasonable and simple structure, convenient to use, unlimited player activity range, and strong participation sense and high degree of intelligence, etc., which effectively solve the problem that the traditional gun-shaped game controller is not easy to store.

### FIELD OF THE INVENTION

The invention relates to the field of game external devices. In particular, the invention relates to an easy-to-store combined wireless gun-shaped simulation game controller.

### BACKGROUND

At present, shooting games account for a big market share in the game industry. However, no matter whether it is on PC or PS, Xbox and other game platforms, the mainstream control mode is still the traditional keyboard plus mouse or traditional game controller. The operation mode lacks the participation sense and realism sense of the game, and the keyboard, mouse and gamepad are usually wired connections, which limits the range of activities of the game player. The player can only sit in a fixed position to operate the game, which is easy to cause health problems. Therefore, there are game handles that are connected to game devices by wireless connection and have a gun-shaped appearance. In order to achieve a good simulation effect, these handles are generally large in size and difficult to store, and the operation mode is simply to transplant the operation buttons to the gun. On the handle, it has less function and low degree of intelligence.

### SUMMARY OF THE INVENTION

The technical problem to be solved is to overcome the above-mentioned deficiency by providing an easy-to-store combined wireless gun-shaped simulation game controller, which has a reasonable and simple structure, convenient to use, unlimited player activity range, and strong participation sense and high degree of intelligence, etc., which effectively solve the problem that the traditional gun-shaped game controller is not easy to store.

The technical solution of the prevent invention is to provide an easy-to-store combined wireless gun-shaped simulation game controller, which includes a gun-shaped body, a recoil simulation device, a barrel device, a reloading device, an aiming device and a controller. The gun-shaped body is provided with a bolt, a first distance sensor, a second distance sensor, a trigger and a rotary switch.

The trigger is hinged on the gun-shaped body. The first distance sensor and a first return spring are respectively disposed on both sides of the trigger. One end of the bolt is provided with a second return spring and is slidably connected with the gun-shaped body. Two ends of the second return spring are respectively abutted with the bolt and the gun-shaped body. The second distance sensor is disposed on the axis of the bolt. The gun-shaped body is further provided with a T-shaped slot, and fixed metal contacts are disposed at two ends of the T-shaped slot.

The rotary switch includes a rotating wheel and a circular bracket. The rotating wheel is provided with a marking recognition device. The circular bracket is provided with a plurality of position identifiers.

The recoil simulation device includes an electric cylinder disposed in the buttstock, a support plate, a pair of guiding rods and a tension spring. One end of the guiding rod is fixedly connected with the support plate. The other end of the guiding rod is slidably connected to the buttstock. The tension spring is sleeved on a guiding shaft. The support plate is provided with a third magnet. An iron plate on the main shaft of the electric cylinder is connected with the third magnet.

The recoil simulation device further includes a T-shaped block engaged with a T-shaped slot, and a movable metal contact. One end of the movable metal contact abuts against a third return spring disposed on the buttstock, and is electrically connected to the electric cylinder. The other end of the movable metal contact passes through the T-shaped block and abuts against the fixed metal contact.

The barrel device is provided with a first button, and the first button is connected to the controller through a connector. The gun-shaped body and the barrel device are sleeved with each other and locked by a threaded sleeve. The joint of the gun-shaped body and the barrel device is provided with a chute and a slide rail which is slidably connected to the chute.

The reloading device is disposed in a cartridge housing which forms an integrated structure with the gun-shaped body. The reloading device includes a pressure plate, a pressure sensor, a lithium battery and a second button. One end of the pressing plate is hinged with the gun-shaped body. The free end of the pressure plate and the pressure sensor abut each other and both extend out of the cartridge housing.

The controller is disposed in the inner cavity of the gun-shaped body. A wireless transceiver device, a gyroscope and a gravity sensor are integrated on the controller.

Further, the rotating wheel is further provided with a first magnet. The circular bracket is further provided with a second magnet. The first magnet and the second magnet attract each other.

Further, the second magnet and the position identifiers are alternatively arranged. When the first magnet attracts the second magnet, the marking recognition device aligns with the position identifiers.

Further, the support plate is further provided with a cushion.

Further, the recoil simulation device is provided with a telescopic sleeve.

Further, the aiming device includes a sensor group disposed on the gun-shaped body and a sight. The sight is provided with a display screen.

Further, one end of the threaded sleeve is rotatably connected to the gun-shaped body, and is engaged with a convex ring on the gun-shaped body for axial limitation. The chute and the slide rail slidably connected thereto are respectively laterally disposed at the joint of the gun-shaped body and the barrel device.

The technical effect of the present invention is to provide an easy-to-store combined wireless gun-shaped simulation game controller, which includes a gun-shaped body, a recoil simulation device, a barrel device, a reloading device, an aiming device and a controller. The gun-shaped body, the recoil simulation device, the barrel device and the aiming device adopt a split design, which can be freely combined according to the needs. The recoil simulation device simulates the recoil of the firearm by kicking shoulder, which brings more realistic sense, compared with vibrating simulation of the existing game handles. When the player's eyes are close to the sight, the screen automatically switches to the built-in LCD on the sight, which further enhances the game's sense of participation and realism. In addition, the controller is connected to the game console or PC, and does not limit the player's range of activities, which is beneficial to players' health. An easy-to-store combined wireless gun-shaped simulation game controller has a reasonable and simple structure, convenient to use, unlimited player activity range, and strong participation sense and high degree of intelligence, etc., which effectively solve the problem that the traditional gun-shaped game controller is not easy to store.

### BRIEF DESCRIPTION OF THE DRAWINGS

The invention is illustrated by the following figures and embodiments.

FIG. 1 shows a schematic diagram of whole structure of an easy-to-store combined wireless gun-shaped simulation game controller in accordance with an example embodiment.

FIG. 2 shows a schematic diagram of internal structure of an easy-to-store combined wireless gun-shaped simulation game controller in accordance with an example embodiment.

FIG. 3 shows a schematic diagram of a rotary switch of an easy-to-store combined wireless gun-shaped simulation game controller in accordance with an example embodiment.

FIG. 4 shows a schematic diagram of a recoil simulation device of an easy-to-store combined wireless gun-shaped simulation game controller in accordance with an example embodiment.

FIG. 5 shows a schematic diagram of connection of a recoil simulation device and a gun-shaped body of an easy-to-store combined wireless gun-shaped simulation game controller in accordance with an example embodiment.

FIG. 6 shows a schematic diagram connection of a gun-shaped body and a barrel device of an easy-to-store combined wireless gun-shaped simulation game controller in accordance with an example embodiment.

The reference numbers of the figures are as follows:

1: gun-shaped body; 11: trigger; 111: first distance sensor; 112: first return spring; 12: bolt; 121: second return spring; 122: second distance spring; 13: rotary switch; 131: rotating wheel; 132: circular bracket; 133: position identifier; 134: marking recognition device; 135: second magnet; 136: first magnet; 14: sensor group; 15: second button; 16: T-shaped slot; 17: fixed metal contract; 18: threaded sleeve; 19: chute; 2: recoil simulation device; 20: support plate; 21: telescopic sleeve; 22: cushion; 23: T-shaped block; 24: movable metal contract; 25: third return spring; 26: electrical cylinder; 261: iron plate; 27: guiding rod; 28: tension spring; 29: third magnet; 3: barrel device; 31: first button; 32: slide rail; 33: connector; 4: reloading device; 41: lithium battery; 42: pressure sensor; 43: pressure plate; 5: aiming device; 51: sight; 52: display screen; 6: controller.

### DETAILED DESCRIPTION

The invention is illustrated in accordance with figures. The figures as simplified diagrams demonstrate the basic structures of the apparatus of embodiments of the invention. Thus, the invention is not limited to the figures.

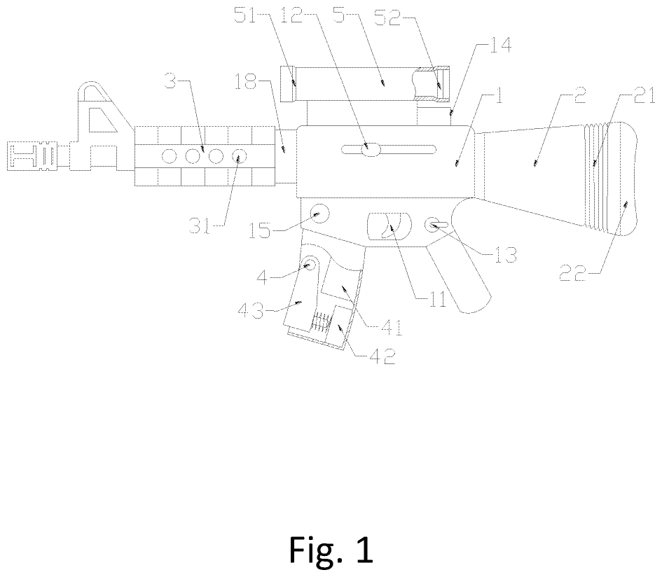

As shown in FIG. 1, an easy-to-store combined wireless gun-shaped simulation game controller includes a gun-shaped body 1, a recoil simulation device 2, a barrel device 3, a reloading device 4, an aiming device 5 and a controller 6.

The gun-shaped body 1 is provided with a bolt 12, a first distance sensor 111, a second distance sensor 122, a trigger 11 and a rotary switch 13.

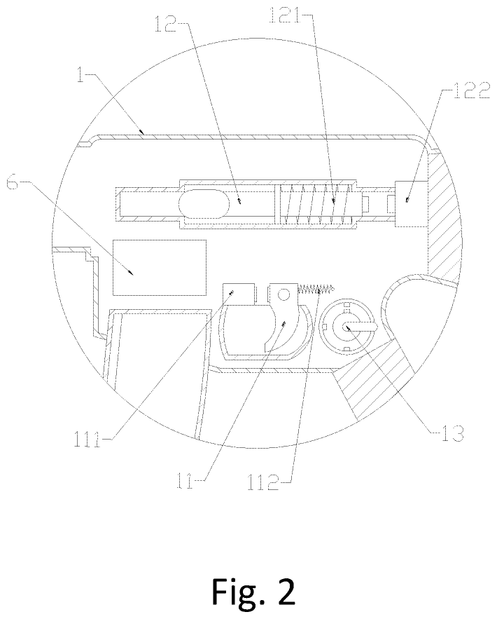

As shown in FIG. 2, the trigger 11 is hinged on the gun-shaped body 1. The first distance sensor 111 and a first return spring 112 are respectively disposed on both sides of the trigger 11. Two ends of the first return spring 112 are respectively connected to one end of the trigger 11 and the inner cavity of the gun-shaped body 1 to form a resistance when the trigger 11 is pulled.

One end of the bolt 12 is provided with a second return spring 121 and is slidably connected with the chute or the inner cavity of the gun-shaped body 1. Two ends of the second return spring 121 are respectively abutted with the bolt 12 and the gun-shaped body 1 to form a resistance to pull the bolt 12. The second distance sensor 122 is disposed on the axis of the bolt 12, and determines whether the bolt is pulled by detecting the distance between the end of the bolt 12 and the second distance sensor 122.

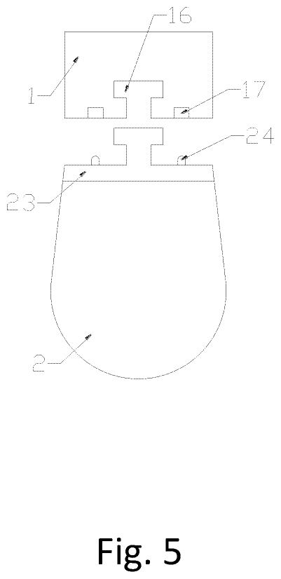

As shown in FIG. 5, the gun-shaped body 1 is further provided with a T-shaped slot 16, and fixed metal contacts 17 are disposed at two ends of the T-shaped slot 16. The fixed metal contacts 17 are electrically connected to the controller 6.

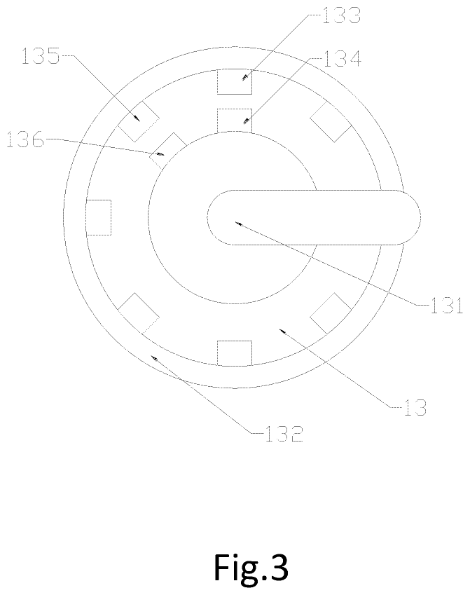

As shown in FIG. 3, the rotary switch 13 includes a rotating wheel 131 and a circular bracket 132. The rotating wheel 131 is provided with a marking recognition device 134. The circular bracket 132 is provided with a plurality of position identifiers 133. Each position identifier 133 is defined by the controller 6 program. When the rotation of the rotating wheel 131 causes the marking recognition device 134 to recognize a certain position identifier 133, the controller 6 executes a corresponding instruction, such as a certain position identifier 133 is defined as pause of the game. When this position identifier 133 is recognized, the game is paused. For ease of operation, the rotating wheel 131 should also be provided with a rotary handle or a toothed structure on the side.

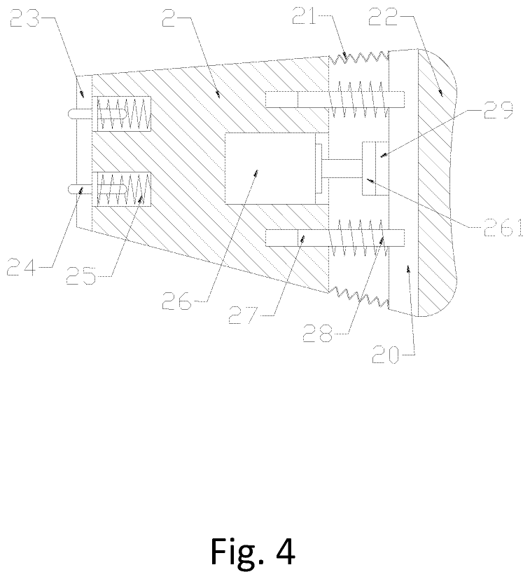

As shown in FIGS. 4 and 5, the recoil simulation device 2 includes an electric cylinder 26 disposed in the buttstock, a support plate 20, a pair of guiding rods 27 and a tension spring 28. One end of the guiding rod 27 is fixedly connected with the support plate 20. The other end of the guiding rod 27 is slidably connected to the buttstock. The tension spring 28 is sleeved on a guiding rod 27. The support plate 20 is provided with a third magnet 29. An iron plate 261 on the main shaft of the electric cylinder 26 is connected with the third magnet 29.

When the trigger 11 is pulled, the electric cylinder 26 is quickly retracted, and the iron plate 261 on the main shaft of the electric cylinder 26 drives the support plate 20 under the attraction of the third magnet 29, and drives the tension spring 28 to retract the accumulative force. When the tension spring 28 is charged to a certain value (greater than the attraction force of the third magnet 29 against the iron plate 261), the third magnet 29 and the iron plate 261 are separated from each other. The support plate 20 hits the player's shoulder under the force of the tension spring 28 being extended, the same as the situation of firearms firing ammunition. The degree of simulation is much greater than the method of installing the vibrating mechanism in the buttstock.

The recoil simulation device 2 further includes a T-shaped block 23 engaged with a T-shaped slot 16, and a movable metal contact 24. One end of the movable metal contact 24 abuts against a third return spring 25 disposed on the buttstock. The third return spring 25 is disposed in the inner cavity of the buttstock. The other end of the movable metal contact passes through the T-shaped block 23 and abuts against the fixed metal contact 17. When the movable metal contact 24 abuts the fixed metal contact 17, the movable metal contact 24 is partially retracted into the buttstock and electrically connected to the electric cylinder 26.

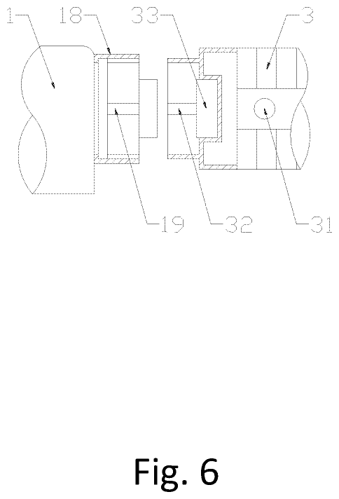

As shown in FIGS. 1 and 6, the barrel device 3 is provided with a first button 31, and the first button 31 is connected to the controller 6 through a connector 33. The function of the first button 31 is defined by the controller 6 program. The gun-shaped body 1 and the barrel device 3 are sleeved with each other and locked by a threaded sleeve 18. The joint of the gun-shaped body 1 and the barrel device 3 is provided with a chute 19 and a slide rail 32 which is slidably connected to the chute for the guiding and positioning when connected.

As shown in FIG. 1, the reloading device 4 is disposed in a cartridge housing which forms an integrated structure with the gun-shaped body 1. The reloading device 4 includes a pressure plate 43, a pressure sensor 42, a lithium battery 41 and a second button 15 which is used to control the game character to stand up, squat or get down. One end of the pressing plate 43 is hinged with the gun-shaped body 1. The free end of the pressure plate 43 and the pressure sensor 42 abut each other and both extend out of the cartridge housing.

The pressure plate 43 is partially exposed outside the cartridge housing, and a certain pressure is transmitted to the pressure sensor 42 by holding the pressure plate 43 to generate a bullet-changing command. The action is consistent with the posture of changing bullet and griping the gun. However, as the players need to keep close eyes on the screen during game, the integrated design of cartridge is not easy to fall which is convenient to operate.

In order to prevent the pressure sensor 42 from being damaged by excessive force, a buffer such as a pad, a spring or the like may be disposed between the pressure plate 43 and the pressure sensor 42.

As shown in FIG. 2, the controller 6 is disposed in the inner cavity of the gun-shaped body 1. A wireless transceiver device, a gyroscope and a gravity sensor are integrated on the controller 6.

In an example embodiment as shown in FIG. 3, the rotating wheel 131 is further provided with a first magnet 136. The circular bracket 132 is further provided with a second magnet 135. The first magnet 136 and the second magnet 135 attract each other. The second magnet 135 and the position identifiers 133 are alternatively arranged. When the first magnet 136 attracts the second magnet 135, the marking recognition device 134 aligns with the position identifiers 133. In other words, the first magnet 136 and the second magnet 135 are attracted to guide the marking recognition device 134 and the position identifier 133 to be aligned.

In an example embodiment of FIG. 4, the support plate 20 is further provided with a cushion 22 to prevent player's shoulders being hurt.

In an example embodiment of FIG. 1 or 4, the recoil simulation device 2 is provided with a telescopic sleeve 21 to prevent the player's clothing, hair, external dust, etc. from falling into it.

The aiming device 5 includes a sensor group 14 disposed on the gun-shaped body 1 and a sight 51 engaged with the gun-shaped body 1. The sight 51 is provided with a display screen 52. The sensor group 14 is provided with an infrared proximity sensor. When the player's face is close to the sensor group 14, the game scene is zoomed and aimed on the display screen 52 provided in the sight 51 or other screens displaying the game screen. Of course, in order to reduce the error, it is also necessary to add a temperature sensor to the sensor group 14 to detect whether what approaches the sensor group 14 is player's face or hair or clothes, etc. which may cause an error to trigger zooming.

In an example as shown in FIG. 6, one end of the threaded sleeve 18 is rotatably connected to the gun-shaped body 1, and is engaged with a convex ring on the gun-shaped body 1 for axial limitation. The gun-shaped body 1 is sleeved in the barrel device 3, and the surface of the barrel device 3 is provided with a thread and is screwed to the threaded sleeve 18. The chute 19 and the slide rail 32 slidably connected thereto are respectively laterally disposed at the joint of the gun-shaped body 1 and the barrel device 3. The chute 19 and the slide rail 32 guide the connection of the connector 33 and determine the relative positions of the gun-shaped body 1 and the barrel device 3.

An easy-to-store combined wireless gun-shaped simulation game controller of the present invention includes a gun-shaped body, a recoil simulation device, a barrel device, a reloading device, an aiming device and a controller. The gun-shaped body, the recoil simulation device, the barrel device and the aiming device adopt a split design, which can be freely combined according to the needs. The recoil simulation device simulates the recoil of the firearm by kicking shoulder, which brings more realistic sense, compared with vibrating simulation of the existing game handles. When the player's eyes are close to the sight, the screen automatically switches to the built-in LCD on the sight, which further enhances the game's sense of participation and realism. In addition, the controller is connected to the game console or PC, and does not limit the player's range of activities, which is beneficial to players' health. An easy-to-store combined wireless gun-shaped simulation game controller has a reasonable and simple structure, convenient to use, unlimited player activity range, and strong participation sense and high degree of intelligence, etc., which effectively solve the problem that the traditional gun-shaped game controller is not easy to store.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An easy-to-store combined wireless gun-shaped simulation game controller, comprising: a gun-shaped body 1, a recoil simulation device 2, a barrel device 3, a reloading device 4, an aiming device 5 and a controller 6, wherein the gun-shaped body 1 is provided with a bolt 12, a first distance sensor 111, a second distance sensor 122, a trigger 11 and a rotary switch 13,
wherein the trigger 11 is hinged on the gun-shaped body 1; the first distance sensor 111 and a first return spring 112 are respectively disposed on both sides of the trigger 11; one end of the bolt 12 is provided with a second return spring 121 and is slidably connected with the gun-shaped body 1; two ends of the second return spring 121 are respectively abutted with the bolt 12 and the gun-shaped body 1; the second distance sensor 122 is disposed on the axis of the bolt 12; the gun-shaped body 1 is further provided with a T-shaped slot 16, and fixed metal contacts 17 are disposed at two ends of the T-shaped slot 16,
wherein the rotary switch 13 includes a rotating wheel 131 and a circular bracket 132; the rotating wheel 131 is provided with a marking recognition device 134; the circular bracket 132 is provided with a plurality of position identifiers 133,
wherein the recoil simulation device 2 includes an electric cylinder 26 disposed in the buttstock, a support plate 20, a pair of guiding rods 27 and a tension spring 28; one end of the guiding rod 27 is fixedly connected with the support plate 20; the other end of the guiding rod 27 is slidably connected to the buttstock; the tension spring 28 is sleeved on a guiding rod 27; the support plate 20 is provided with a third magnet 29; an iron plate 261 on the main shaft of the electric cylinder 26 is connected with the third magnet 29,
wherein the recoil simulation device 2 further includes a T-shaped block 23 engaged with a T-shaped slot 16, and a movable metal contact 24; one end of the movable metal contact 24 abuts against a third return spring 25 disposed on the buttstock; the third return spring 25 is disposed in the inner cavity of the buttstock; the other end of the movable metal contact passes through the T-shaped block 23 and abuts against the fixed metal contact 17,
wherein the barrel device 3 is provided with a first button 31, and the first button 31 is connected to the controller 6 through a connector 33; the gun-shaped body 1 and the barrel device 3 are sleeved with each other and locked by a threaded sleeve 18; the joint of the gun-shaped body 1 and the barrel device 3 is provided with a chute 19 and a slide rail 32 which is slidably connected to the chute,
wherein the reloading device 4 is disposed in a cartridge housing which forms an integrated structure with the gun-shaped body 1; the reloading device 4 includes a pressure plate 43, a pressure sensor 42, a lithium battery 41 and a second button 15; one end of the pressing plate 43 is hinged with the gun-shaped body 1; the free end of the pressure plate 43 and the pressure sensor 42 abut each other and both extend out of the cartridge housing,
wherein the controller 6 is disposed in the inner cavity of the gun-shaped body 1; a wireless transceiver device, a gyroscope and a gravity sensor are integrated on the controller 6.

2. The easy-to-store combined wireless gun-shaped simulation game controller of claim 1, wherein the rotating wheel 131 is further provided with a first magnet 136; the circular bracket 132 is further provided with a second magnet 135; the first magnet 136 and the second magnet 135 attract each other.

3. The easy-to-store combined wireless gun-shaped simulation game controller of claim 2, wherein the second magnet 135 and the position identifiers 133 are alternatively arranged; when the first magnet 136 attracts the second magnet 135, the marking recognition device 134 aligns with the position identifiers 133.

4. The easy-to-store combined wireless gun-shaped simulation game controller of claim 1, wherein the support plate 20 is further provided with a cushion 22.

5. The easy-to-store combined wireless gun-shaped simulation game controller of claim 1, wherein the recoil simulation device 2 is provided with a telescopic sleeve 21.

6. The easy-to-store combined wireless gun-shaped simulation game controller of claim 1, wherein the aiming device 5 includes a sensor group 14 disposed on the gun-shaped body 1 and a sight 51 engaged with the gun-shaped body 1; the sight 51 is provided with a display screen 52.

7. The easy-to-store combined wireless gun-shaped simulation game controller of claim 1, wherein one end of the threaded sleeve 18 is rotatably connected to the gun-shaped body 1, and is engaged with a convex ring on the gun-shaped body 1 for axial limitation; the chute 19 and the slide rail 32 slidably connected thereto are respectively laterally disposed at the joint of the gun-shaped body 1 and the barrel device 3.
